(19) United States
(12) Patent Application Publication
(10) Pub. No.: US 2016/0078540 A1
(43) Pub. Date: Mar. 17, 2016

(54) Online trading method and system for distributed advertising and trading of securities transactions

(71) Applicant: Sean Michael Raimbeault, Phoenix, AZ (US)

(72) Inventor: Sean Raimbeault, Phoenix, AZ (US)

(21) Appl. No.: 14/952,950

(22) Filed: Nov. 26, 2015

(51) Int. Cl. G06Q 40/04

(52) U.S. Cl. CPC G06Q 40/04

(57) ABSTRACT

A method and system to facilitate advertisements and transactions of financial securities that are not listed on public securities exchanges through a website. Examples of such securities include stocks, options, and bonds. Buyers and sellers interact directly with each other by private negotiation, thereby obviating the need for services of a securities broker or traditional securities exchanges. A computerized communications network, such as the Internet, is used as a security for implementing the transactions. A website is utilized to facilitate transactions directly between buyers and sellers.

### CROSS REFERENCE TO RELATED APPLICATIONS

Not Applicable

### BACKGROUND OF THE INVENTION

The present invention relates generally to the online processing of securities transactions in a multi-user environment. More particularly, the invention relates to an advertising and negotiation system for the trading of securities directly by buyers and sellers, obviating the need of the services of a broker-dealer or traditional securities exchanges.

In a traditional securities markets, individuals are generally restricted from buying and selling ownership or debt interests in corporations that are publically listed on established exchanges. Such trading transactions take place through broker-dealer of securities. Such ownership interests may be traded by trading of shares of company stock trading options on a stock, and/or trading interests of holding companies or mutual funds that own a portion of a company. Generally, such ownership interests are herein termed “securities”.

Securities exchanges function as continuous auction markets, with broker-dealer s representing buyers and sellers in consummating transactions through a central clearinghouse called an exchange. Securities broker-dealer s in the United States and abroad currently exchange most orders on a trading floors Traditional securities exchanges, such as the New York Stock Exchange and the Nikkei.

Traditional exchanges restrict the purchase and sale of securities on their trading floors to securities broker-dealers the exchange has approved. Such broker-dealers buy and sell securities on behalf of investors, and for their own accounts.

Traditional exchanges restrict the purchase and sale of securities on their trading floors to issuer companies that have been approved for listing on their exchanges. Each exchange has specific listing entry requirements, including earnings history, shareholders' equity, market capitalization, and requirements for numbers of existing and expected shareholders.

One drawback of the current process is that it virtually guarantees that a large portion of potential issuer companies, namely growing small companies, will remain excluded from capital markets. The current process places an inordinate burden on such potential issuers due to the underwriting costs and broker-dealer age fees associated with offering securities through existing exchanges.

Another drawback to the current system are the listing requirements of traditional exchanges, which combine to create high barriers of entry for many potential company issuers, such as small businesses.

Another drawback of the current system is that a large pool of potential capital sources, namely smaller individual investors, are generally excluded from the opportunity to invest in initial public offerings of securities.

Another drawback of the current system is that traditional exchanges preclude buyers and sellers from exchanging directly by requiring that securities be traded through the services of a broker-dealer, with the expense of such services charged to the investor.

What would be useful is a method and system where investors and securities issuers could trade securities directly with each other over a network obviating the . Such a method and system would provide information about securities that match user defined criteria and/or interests of investors. Such a system would allow sellers to post asking prices and buyers to place offers for quantities of securities. Such a system would provide users with historical selling prices and financial performance of such securities. Such a system would allow a review of the business underlying the securities and may include information such as operating statements, financial statements, tax returns, executives, business plans, and ancillary information, such that potential buyers and sellers can render informed investment decisions. Thus, an online trading method and system for distributed advertising and trading of securities transactions solving the aforementioned problems is desired.

On Mar. 25, 2015, The United States Securities and Exchange Commission (SEC) adopted final rules to facilitate smaller companies' access to capital markets and to provide investors with more investment choices. The new rules update and expand Regulation A, an existing exemption from registration for smaller issuers of securities. The rules are mandated by Title IV of the Jumpstsrt Our Business Startups (JOBS) Act. The updated exemption enables smaller companies to either directly issue, offer or sell up to $50 million of securities in a 12-month period, subject to SEC rules of eligibility, disclosure and reporting requirements.

One object of this invention is to advance the current system by providing a method and system to buyers and sellers, including issuers of securities, for direct access to each other for the purpose of advertising and trading securities of companies not listed on public exchanges. The invention assists buyers and sellers in exchanging information, negotiating, directly trading securities with each other, obviating the need for buyers and sellers to trade securities through broker-dealer intermediaries or traditional exchanges.

Another object of this invention is a system to create a market for securities that are underserved or not served by existing markets.

Another object of this invention is a system to allow buyers and sellers to simply and easily make and report trades

Another object of this invention is a system by which small company securities issuers not served by existing broker-dealer s and exchanges raise capital by directly advertising and issuing securities to interested qualified investors.

Additional objects and advantages of the invention will be set forth in part in the description which follows, and in part will be obvious from the description, or may be learned by practice of the invention. These and other features of the present invention will become readily apparent upon further review of the following specifications and drawings.

### BRIEF SUMMARY OF THE INVENTION

The problems outlined above are at least in part addressed by preferred embodiments of the present invention of an online trading method and system for distributed advertising and trading of securities transactions

In the preferred embodiment, registered users of the system would connect through an online website. A system user who is a seller of securities creates and advertisement for the sale of securities, describes the securities, establishes a target price, specific quantity of securities that are being offered for sale. The system displays the sellers offers for the sale of a securities at certain price, a specific quantity, for a specific period of time. A system user who is a buyer of securities makes an offer to purchase the securities directly to the seller, including an offer price and corresponding quantity of securities for a specific period of time. The system further automatically calculates a suggested exchange value for the securities based, at least in part, on information associated with the securities, past and/or current offers for securities, and/or time remaining until the expiration of an offer to buy or an offer to sell. Additionally, the system is configured for either the seller and/or the buyer to provide a final exchange offer for a securities. Further, the system is configured for the seller or buyer to receive an indication of acceptance or rejection of a final proposed exchange.

To achieve the objects of the invention embodied and broadly described herein, the present invention includes a method of this invention that operates in a data processing system providing a user interface with an online system over which securities may be traded directly between seller and buyer. A system database containing information to be shown in system displays that show information about the securities. The method comprises the steps, implemented by the data processing system, of: receiving from a user a first input requesting a display indicating which system display shows information about a desired securities; displaying, in response to the first input, the display; receiving a second input from the user indicating a change in the system display that shows the information about the desired securities; and updating the system display database to reflect the changes indicated by the second input.

Another method according to this invention of providing information on securities uses a data processing system providing a user interface with a securities exchange system for trading securities. Users trade securities that have an associated set of information. The method comprises the steps, implemented by the data processing system, of; receiving, from a user a first input requesting a display for the desired securities, the display containing a predetermined subset of information selected from the set of information associated with the desired securities; displaying the display containing a predetermined subset of information for the desired securities; receiving a second input from the user specifying a trade of the desired securities; executing the trade; and reporting the trade of the securities to a second database.

Another method of providing information to a user on selected securities according to this invention operates also in a data processing system that provides a user interface. The method comprises the steps, implemented by the data processing system, of: creating a first window containing a plurality of icons each associated with a different securities; displaying the first window; receiving from the user a second input selecting one of the plurality of icons: and displaying, in response to the second input, a second window containing information and functions associated with the securities associated with the selected icon.

Both the foregoing general description and the following detailed description are only exemplary and explanatory and do not restrict the invention as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 illustrates the components of a computer network system which can embody this invention.

FIG. 2 illustrates steps that can be taken to implement an online trading method and system for distributed advertising and trading of securities transactions,

### DETAILED DESCRIPTION OF THE INVENTION

The trading of securities directly between sellers to buyers without intermediaries, such as securities broker-dealers or traditional exchanges, can be facilitated through a computer implemented online trading method and system for distributed advertising and trading of securities.

In one embodiment, the present invention allows for the trade of securities that are not listed on traditional exchanges. Typically, a transaction will be consummated via a communications network by participants operating a network access device, such as a computer.

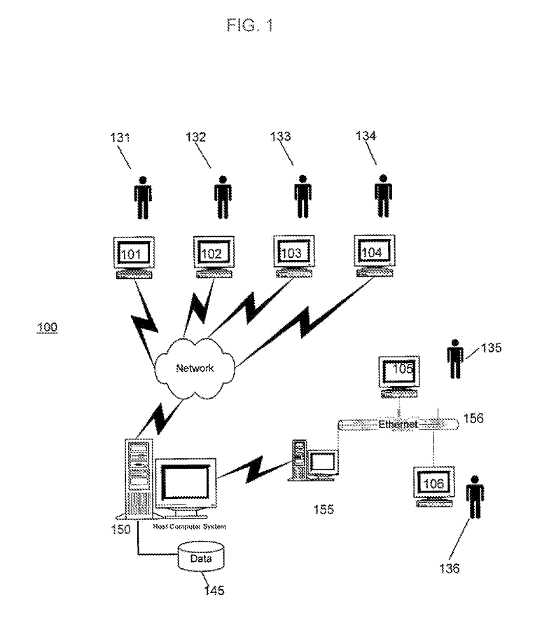

FIG. 1 shows a network of computers 100 that may be used in an implementation of an online trading method and system for distributed advertising and trading of securities. The network 100 can include a host computer system 150 and system user computers 101-106. Each of the user computers can include a processor, memory, user input device, such as a keyboard and/or mouse, and a user output device, such as a video display, flat panel display and/or a printer. The user computers 101-106 can communicate with the host 150 to exchange transaction information. The transaction information can be stored as data on a storage medium 145 at the host 150. A user 131-136 operating a user computer 101-106 may offer to buy and to sell securities listed on the system. The process can be effected with a host computer 150, or details of transaction can be transmitted to a host computer 150.

The host 150 may include multiple processing and database subsystems, such as cooperative or redundant processing and/or database servers, which can be geographically dispersed throughout the network 100. In some implementations, groups of e-commerce participant computers 105-106 may communicate with a host 150 through a local network 158. The local network 155 can also include a local server such as a proxy server or a caching server.

The host computer 150 includes one or more databases 145 storing securities and transaction information and applications. A large variety of files may be stored at the host 150; for example, text, data audio, video, graphics, animations, and illustrations. In addition, the host 150 interacts with, and gathers data from a e-commerce participant via an e-commerce participant computer 101-106. Data gathered from the e-commerce participant may be used to conduct e-commerce and/or to project future sales.

A system user can access the host 150 using software executed at the users computer 101-106. The software may include a generic hypertext markup language (HTML) browser, such as Netscape Navigator or Microsoft Internet Explorer, (a “WEB browser”). The software may also be a proprietary browser, and/or other host access software. In some cases, an executable program, such as a Java™ program, may be downloaded from the host 150 to the users computer and executed at the users computer.

The website of this invention can contain user rules and procedures. In addition, all relevant information regarding one or more securities is be posted on the website. Such information may include: Information about specific securities, information on the issuer company, history and details of past transactions relating to a securities, statements and information from sellers, user generated reviews and information, terms and conditions of sale. Users have the opportunity to offer to sell and to buy securities posted on the system. A seller determines which offers, if any, to accept.

in one embodiment, the buyers can be required to meet seller selected criteria. The website can be interactive to ascertain that users are meet certain criteria. Upon seller's acceptance of an offer by a buyer, both the buyer and seller would be deemed to have agreed to the terms of sale.

in various embodiments, sellers and issuers receive indemnifications from buyers.

The use of the website to advertise securities will facilitate evaluation of the securities in a timely manner and has the potential to vastly broaden the base of issuers, sellers, and buyers in the U.S. and abroad.

The invention facilitates efficient and competitive trading of securities by marketing securities to a broad base of interested investors. At the time securities are marketed through the invention, the market price will reflect the best available price for those securities in specific quantities at any point in time. All relevant and available information with respect to a particular securities that may legally be disclosed will be made available to all users, as is practiced on traditional exchanges.

All advertising, marketing, and other information presented over the system will be structured in a manner consistent with compliance of all applicable securities laws in the U.S. and abroad. In addition, the transfer securities over the system may implicate the securities laws of various jurisdictions. All transactions will be structured to comply with such laws.

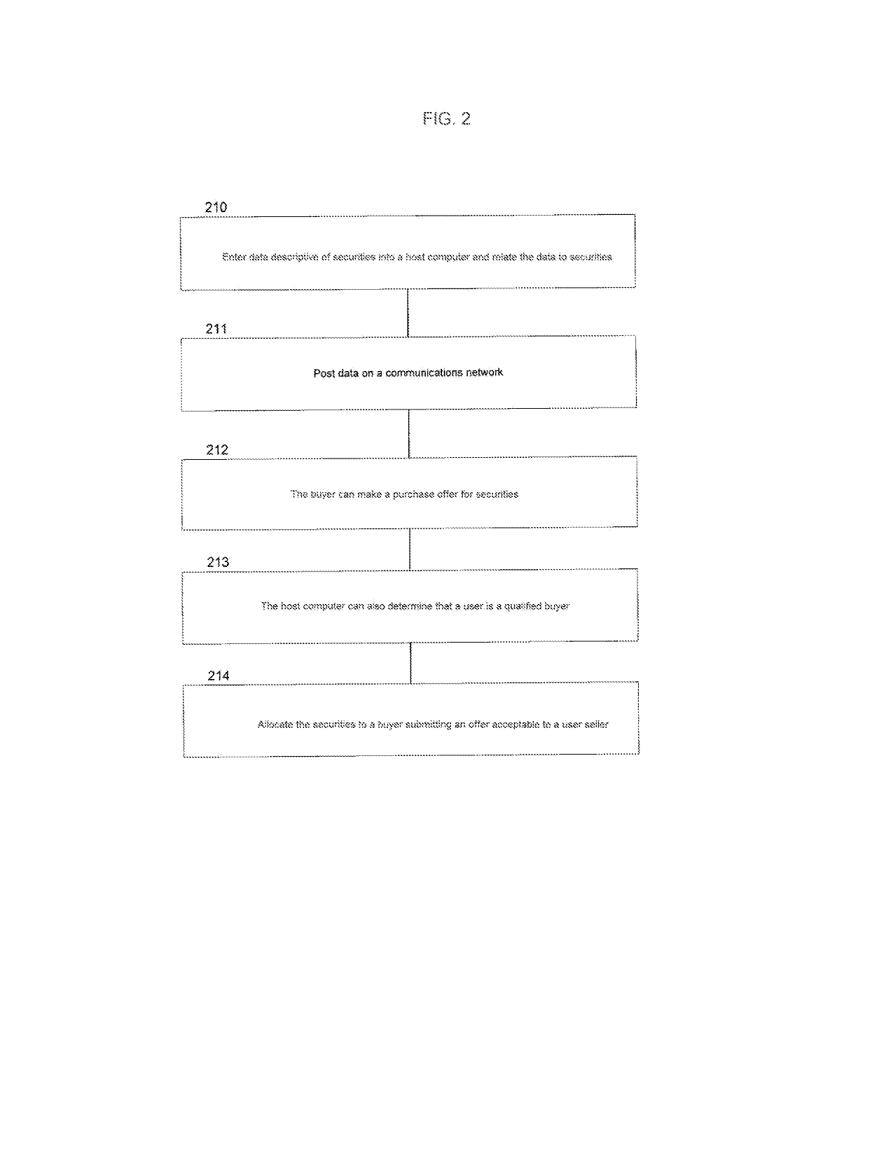

Referring now to FIG. 2, a user of the present invention can enter data descriptive of securities into a host computer and relate the data to securities 210. The host computer can present the data on a communications network such that it can be viewed by a user who is a potential buyer 211. The buyer can make a purchase offer for securities via a network access device such that the host computer receives the offer. The host computer can also determine that a user is a qualified buyer 213 and allocate the securities to a buyer submitting an offer acceptable to a user seller 214.

The invention may be manifested in digital electronic circuitry, or in computer hardware, firmware, software, or in combinations of them. Apparatus of the invention may also be implemented in a computer program product tangibly embodied in a machine-readable storage device for execution by a programmable processor; and method steps of the invention may be performed by a programmable processor executing a program of instructions to perform functions of the invention by operating on input data and generating output.

One or more computer programs can be executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors.

A number of embodiments of the present invention have been described. Nevertheless, it will be understood that various modifications may be made without departing from the spirit and scope of the invention. For example, user computers 101-106 can comprise a personal computer executing an operating system such as Microsoft Windows™, Unix™, or Apple MacOS™, as well as software applications, such as a web browser. User computers 101-106 can also be terminal devices, portable computer devices, and/or web access devices that adhere to a point-to-point or network communication protocol such as the Internet protocol. Other examples can include terminals, and wireless access devices (such as smart mobile phones). A user computer may include a processor, RAM and/or ROM memory, a display capability, an input device and hard disk or other relatively permanent storage. Accordingly, other embodiments are within the scope of the following claims. Similarly, the host system 150 and the system can be any computer system known to those skilled in the art.

1. A computer implemented method for advertising and trading securities not listed on public exchanges directly between buyers and sellers by private negotiation, the method comprising: entering data descriptive of a securities into a host computer; entering a set of terms, conditions and rules applicable to a relevant category of securities sales; entering information related to securities; entering information related to securities issuers; entering an offer to sell securities for a specified price, quantity, and period of time; entering an offer to purchase securities for a specified price, quantity, and period of time; automatically calculating a suggested exchange value for the securities based, at least in part, on information associated with the securities, past and/or current offers for securities, and/or time remaining until the expiration of an offer to buy or an offer to sell; the host computer calculating a suggested exchange value for the securities based, at least in part, on information associated with the securities, past and/or current offers for securities, and/or time remaining until the expiration of an offer to buy or an offer to sell; the host computer configured for either the seller and/or the buyer to provide a final exchange offer for a securities; and, the host computer configured both seller and buyer to receive an indication of acceptance or rejection of a final proposed exchange.

2. The method of claim 1, wherein information relating to securities is stored on a host computer.

3. The method of claim 1, wherein a transaction is negotiated directly between buyers and sellers, thus obviating the need to trade on public securities exchanges.

4. The method of claim 1, wherein the data is presented on a website via the Internet.

5. The method of claim 1, wherein the communications network comprises the Internet.

6. The method of claim 1, additionally comprising the step of basing offers upon a seller's offer.

7. The method of claim 1, additionally comprising the step of designating sellers and buyers as qualified parties according to a predetermined set of criteria.

8. A computer communications system for advertising and trading securities not listed on public exchanges directly between buyers and sellers by private negotiation, the system comprising: a computer communications server accessible with a network access device via a communications network; and executable software stored on the server and executable on demand via the network access device, the software operative with the server to: enter data descriptive of a securities relating to a proposed transaction into a host computer; present the date over a communications network; receive an offer to purchase securities into the host computer, wherein the offer is based on a sellers offer to sell; and ensure compliance of the transaction with a set of rules and procedures applicable to a relevant category of securities transactions.

9. A computer executable program code residing on a computer-readable medium, the program code comprising instructions causing the computer to: enter data descriptive of a securities relating to securities transaction into a host computer; present the data on a communications network; receive an offer to purchase securities on the host computer, wherein the offer is based on a seller's offer to sell; and ensure compliance of the securities transaction with a set of securities rules and procedures applicable to a relevant category of securities transactions.

10. A computer data signal embodied in a digital data stream comprising data including details of securities relating to a transaction, wherein the computer data signal is generated by a method comprising the steps of: entering data descriptive of a securities relating to a securities transaction into a host computer; presenting the data on a communications network; receiving an offer to assume a portion of the securities as part of a securities transaction into the host computer; ensuring compliance of the securities transaction with a set of securities rules and procedures applicable to a relevant category of securities transactions; and allocating the portion of the securities to a buyer submitting an acceptable offer for transactions.

11. A processor-implemented method for advertising and trading securities, the method comprising: receiving data into a host computer, wherein the data is descriptive of securities consisting of those entered into the system; presenting the data and a set of securities transaction terms on a website via the internet; receiving an offer from an user to purchase the securities as part of a securities transaction into the host computer, wherein the offer is based on a sellers offers to sell securities; receiving a set of user qualification data descriptive of an participant's securities characteristics; comparing the set of user qualification data to a set of qualification requirements; and ensuring compliance of a transaction with a set of securities rules and procedures applicable to a relevant category of securities.
